(19) United States
(12) Patent Application Publication
(10) Pub. No.: US 2010/0188341 A1
(43) Pub. Date: Jul. 29, 2010

(54) DISPLAY DEVICE AND TOUCH MODULE THEREOF

(75) Inventor: Chang-Han Shen, Hsinchu (TW)

Correspondence Address: QUINTERO LAW OFFICE, PC, 615 Hampton Dr, Suite A202, Venice, CA, 90291, US

(73) Assignee: MITAC TECHNOLOGY CORP., Hsinchu (TW)

(21) Appl. No.: 12/358,679

(22) Filed: Jan. 23, 2009

(51) Int. Cl. G06F 3/041

(52) U.S. Cl. 345/173

(57) ABSTRACT

A touch module is provided to be applied to a display device. The touch panel includes a touch panel, a first retarder film, a second retarder film, and a polarizer. The touch panel has a display surface and an embedding surface opposite to each other. The first retarder film is disposed on the display surface, the second retarder film is disposed on the embedding surface, and the polarizer is disposed on the first retarder film.

### BACKGROUND OF THE INVENTION

1. Field of Invention

The present invention relates to a display device, and more particularly to a display device and a touch module applied therein, thereby enhancing contrast performance of the display device under strong light.

2. Related Art

FIG. 1 shows a conventional display device 10, which includes a display module 12, and a touch module 50 disposed on a display surface 30 of the display module 12.

The display module 12 is a display panel such as a liquid crystal panel or an organic electroluminescence panel. The touch module 50 includes a touch panel 14 and a polarizer 24 attached to a display surface 26 of the touch panel 14. The touch module 50 is disposed to face the display surface 30 of the display module 12. An embedding surface 28 of the touch module 50 faces the display surface 30 of the display module 12, and the display surface 26 of the touch module 50 faces the user (top of FIG. 1).

The touch panel 14 mainly includes a glass substrate 16 and a polyethylene terephthalate (PET) substrate 18 opposite to each other. A transparent conductive layer 20 is formed respectively on a surface of the glass substrate 16 and a surface of the PET substrate 18. A surface of the PET substrate 18 is defined as the display surface 26, and a surface of the glass substrate 16 is defined as the embedding surface 28. A gap 22 exists between the glass substrate 16 and the PET substrate 18, so as to prevent the transparent conductive layers 20 formed on the glass substrate 16 and the PET substrate 18 from contacting with each other when the touch module 50 is touched and pressed. Here, the touch panel 14 may be a resistive touch panel, a capacitive touch panel, or a touch panel of another type. A gap 40 may exist between the touch module 50 and the display module 12 depending on the demand of assembly, and thus the touch module 50 and the display module 12 are spaced from each other.

In the conventional display device 10 as shown in FIG. 1, when ambient light is transmitting layers within the touch panel 14, light reflection occurs in each layer. Light reflection degrades the image contrast performance of the display device 10. The polarizer 24 is disposed to reduce the amount of the light entering the display device 10, but the effect is limited in a strong light environment (such as direct incidence of the sun light).

In addition, the gap 40 exists between the touch module 50 and the display module 12, and when the light passes through the interface of the gap 40 and the display surface 30, the light reflection described above also occurs, which degrades the image contrast performance of the display device 10 as well.

Furthermore, the glass substrate 16 is relatively heavy, being disadvantageous in the light weight and portability of the display device 10. Further, due to the use of the hard glass substrate 16, the display device 10 lacks of flexibility.

### SUMMARY OF THE INVENTION

Accordingly, the present invention is directed to a touch module and a display device applying the same, thereby enhancing the image contrast performance of the display device under strong light environment.

In an embodiment, a touch module provided by the present invention includes a touch panel having a display surface and an embedding surface opposite to each other, a first retarder film disposed on the display surface, a second retarder film disposed on the embedding surface, and a polarizer disposed on the first retarder film.

In another embodiment, a display device provided by the present invention includes a display module, and a touch module disposed on the display module. The touch module includes a touch panel having a display surface and an embedding surface opposite to each other, a first retarder film disposed on the display surface, a second retarder film disposed on the embedding surface, and a polarizer disposed on the first retarder film.

In a yet another embodiment, the touch module provided by the present invention includes a touch panel having a display surface and an embedding surface, and a polarizer disposed on the display surface of the touch panel.

In another embodiment, a display device provided by the present invention includes a display module, and a touch module disposed on the display module. An embedding surface of the touch module substantially contacts with the display module. The touch module includes a touch panel having a display surface and an embedding surface opposite to each other, and a polarizer disposed on the display surface of the touch panel.

To make the objects, features, and advantages of the present invention described above and the others more comprehensible, detailed illustration is made with reference to accompanying drawings below by way of a preferred embodiment.

### BRIEF DESCRIPTION OF THE DRAWINGS

The present invention will become more fully understood from the detailed description given herein below for illustration only, and thus is not limitative of the present invention, and wherein:

FIG. 1 shows a cross-sectional view of a conventional display device;

FIG. 2 shows a cross-sectional view of a display device according to an embodiment of the present invention;

FIG. 3 shows a cross-sectional view of a display device according to another embodiment of the present invention;

FIG. 4 shows an explosive view of the display device according to an embodiment of the present invention;

FIG. 5 shows a an explosive view of the display device according to another embodiment of the present invention;

FIG. 6 shows a cross-sectional view of a display device according to yet another embodiment of the present invention;

FIG. 7 shows a cross-sectional view of a display device according to another embodiment of the present invention;

FIG. 8 shows an explosive view of the display device according to yet another embodiment of the present invention; and

FIG. 9 shows an explosive view of the display device according to another embodiment of the present invention.

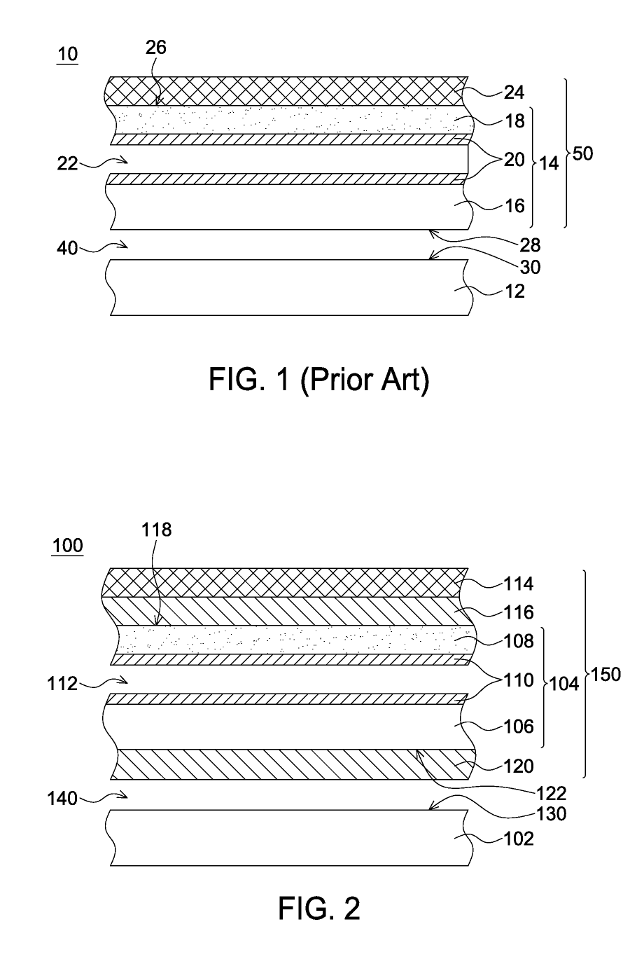

### DETAILED DESCRIPTION OF THE INVENTION

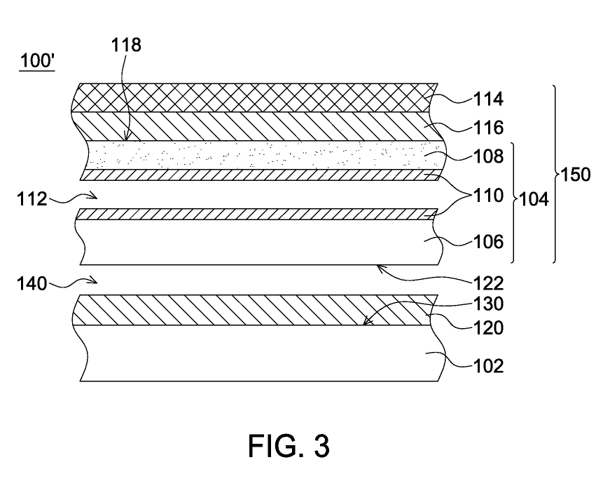

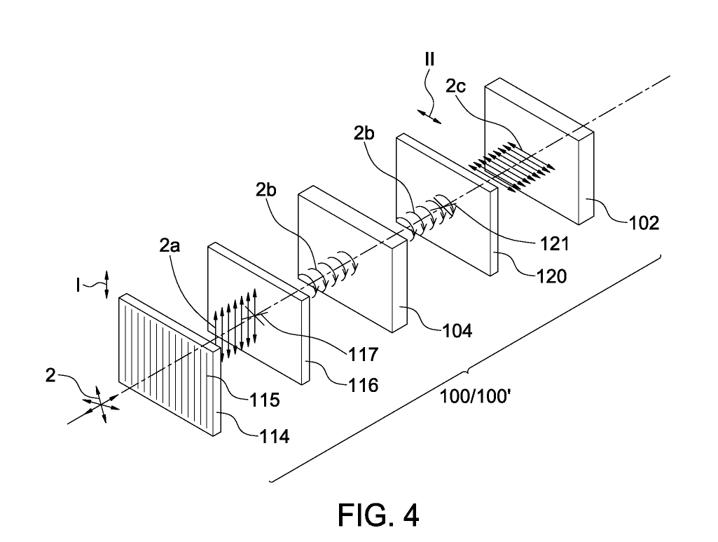

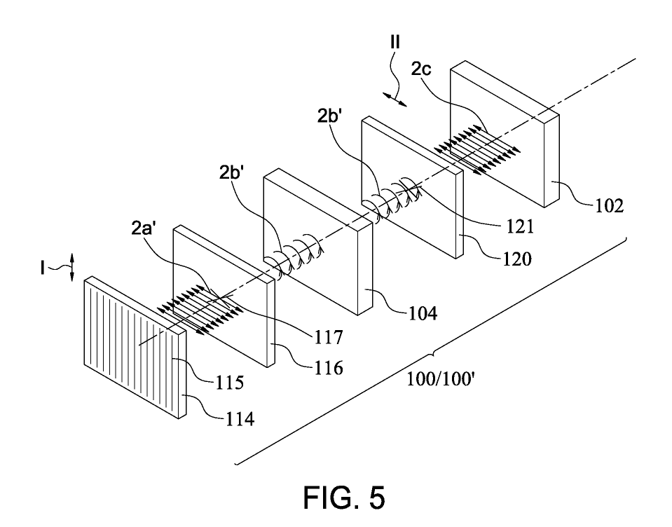

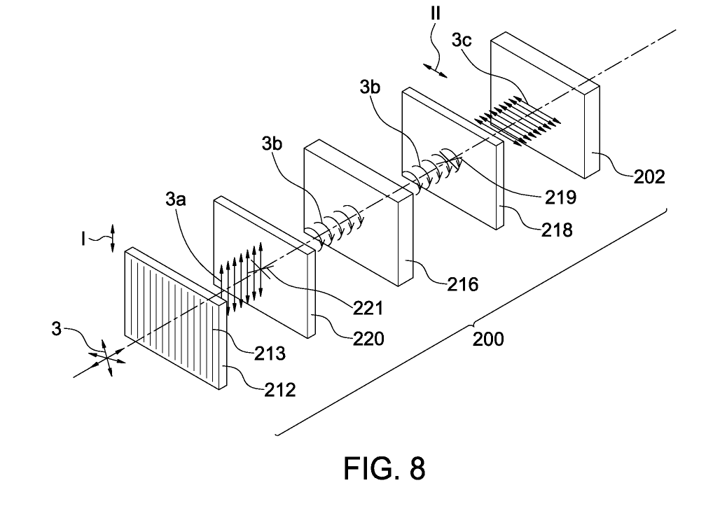

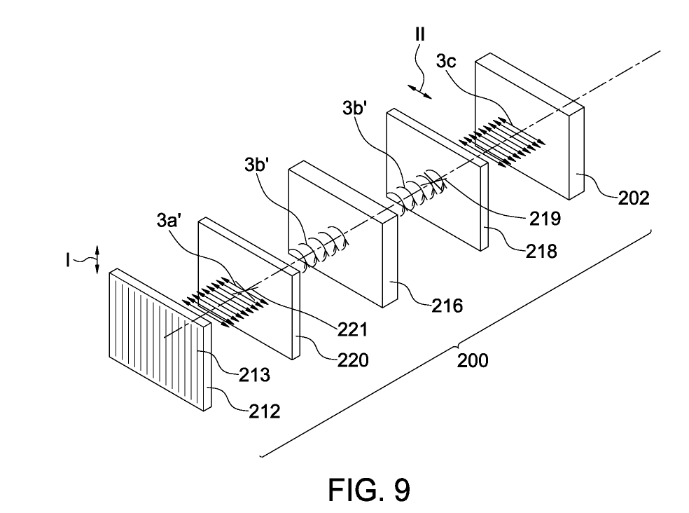

The embodiments of the present invention will be illustrated below with reference to cross-sectional views such as FIGS. 2, 3, 6, and 7. Further, FIGS. 4 and 5 respectively show explosive views of the display device shown in FIGS. 2 and 3. FIGS. 8 and 9 respectively show explosive views of the display device shown in FIG. 7.

Referring to FIG. 2, a cross-section area of a display device 100 according to an embodiment of the present invention is shown. The display device 100 includes a display module 102 and a touch module 150 disposed on the display module 102. The touch module 150 is disposed on a display surface 130 of the display module 102.

As shown in FIG. 2, the display module 102 is, but not limited to, an image display module such as a liquid crystal display (LCD) device or an organic light emitting display (OLED) device. The display module 102 may also be an image display device of another type. The touch module 150 includes a touch panel 104, and a first retarder film 116 and a polarizer 114 formed on a display surface 118 of the touch panel 104 in sequence. Further, an embedding surface 122 of the touch panel 104 is disposed to face the display surface 130 of the display module 102. A second retarder film 120 is formed on the display surface 130. The first and second retarder films 116, 120 are, for example, ¼ wavelength (¼λ) retarder films, and λ is, for example, the wavelength of the visible light.

Here, the touch panel 104 mainly includes a first transparent substrate 106 and a second transparent substrate 108 opposite to each other. The first transparent substrate 106 is a rigid substrate such as a glass substrate. The second transparent substrate 108 is a flexible substrate such as a polyethylene terephthalate (PET) substrate. A transparent conductive layer 110 (such as an indium tin oxide (ITO) layer) is formed respectively on a surface of the first transparent substrate 106 and a surface of the second transparent substrate 108. A surface of the second transparent substrate 108 is defined as the display surface 118, and a surface of the first transparent substrate 106 is defined as the embedding surface 122. A gap 112 exists between the first transparent substrate 106 and the second transparent substrate 108, so as to prevent the transparent conductive layers 110 of the first transparent substrate 106 and the second transparent substrate 108 from contacting with each other when the touch module 150 is touched and pressed. Here, the touch panel 104 is, for example, a resistive touch panel, but the touch panel 104 is not limited to the configuration shown in FIG. 2 to limit the present invention, and may also be a touch panel of another type, such as a capacitive touch panel. Further, a gap 140 exists between the touch module 150 and the display module 102 depending on the demand of assembly, and thus the touch module 150 and the display module 102 are spaced from each other.

In this embodiment, by disposing the first and second retarder films 116, 120 respectively on the display surface 118 and the embedding surface 122 of the touch panel 104 within the display device 100, the reflection of the ambient light in the touch panel 104 and between the touch module 150 and the display module 102 after being incidence to the display device 100 is alleviated. Therefore, it is advantageous in enhancing the contrast of the image display surface and the display device under the strong light environment, and the internal reflection problem encountered by the conventional display device is alleviated.

FIG. 3 shows a section of a display device 100′ according to another embodiment of the present invention. As shown in FIG. 3, the display device 100′ is substantially similar to the display device 100 shown in FIG. 2, the exception is that the second retarder film 120 is disposed on the display surface 130 of the display module 120, and the embedding surface 122 of the first transparent substrate 106 is exposed.

FIGS. 4 and 5 are a series of schematic views showing 3-dimensional view (i.e., polarization principle) of the display device shown FIGS. 2 and 3.

As shown in FIG. 4, the polarizer 114 is, for example, a linear polarizer. A grating 115 having an extending direction I is disposed on the polarizer 114, for filtering the light. The first retarder film 116 is disposed behind the polarizer 114, and has a fast axis grating 117. The first retarder film 116 is, for example, a ¼ wavelength retarder film, or another optical component with deflection function well known by those skilled in the art.

The touch panel 104 is disposed behind the first retarder film 116. The second retarder film 120 is disposed behind the touch panel 104, and the second retarder film 120 also has the fast axis 121. The first retarder film 116 and the second retarder film 120 are arranged such that a 90 degrees deviation angle exists between extending directions of the two fast axis of the first retarder film 116 and the second retarder film 120. The second retarder film 120 may also be a ¼ wavelength retarder film, or another optical component with deflection function well known by those skilled in the art. The display module 102 is disposed behind the second retarder film 120.

In the display device as shown in FIG. 4, after the ambient incident light 2 enters the polarizer 114 of the display device, an incident linearly polarized light 2a with an incident polarization direction similar to the extending direction I of the grating 115 on the polarizer 114 is thus formed. After the incident linearly polarization light 2a enters and passes through the first retarder film 116, an incident circularly polarized light 2b that enters and passes through the touch panel 104 is thus formed, which proceeds to the second retarder film 120 after passing through the touch panel 104. Most of the incident circularly polarized light 2b forms an incident linearly polarized light 2c with a direction 90 degrees deviating from the extending direction I of the grating 115 on the polarizer 114 after passing through the second retarder film 120. The linearly polarized light 2c in turn enters the display device 102.

As shown in FIG. 5, when the incident circularly polarized light 2b enters the second retarder film 120, a portion of the incident circularly polarized light 2b is reflected from the surface of the second retarder film 120, proceeds to the touch panel 104, thereby forming a reflected circularly polarized light 2b′. After the reflected circularly polarized light 2b′ enters and passes through the touch panel 104 and the first retarder film 116, a reflected linearly polarized light 2a′ is thus formed, and proceeds to the polarizer 114. Due to the 90 degrees deviation angle of the polarization direction of the reflected linearly polarized light 2a′ from the extending direction I of the grating 115 of the polarizer 114, the polarizer 114 can block the reflected linearly polarized light 2a′ from passing through the polarizer 114 to the ambient. Similarly, the reflected light reflected from the touch panel 104 and the first retarder film 116 is prevented from entering the ambient by the polarizer 114. In addition to the reflected light of 120, 104 and 116 also produce reflected lights, and 114 can block the reflected lights of 104, 106, and 120.

Referring to implementation of FIGS. 4 and 5, in this embodiment, by disposing the first retarder film 116 and the second retarder film 120 in the display device 100/100′, the reflected circularly polarized light 2b′ generated by the ambient incident light in the touch module within the display device 100/100′ can be converted to the reflected linearly polarized light 2a′ with a phase having been offset by 90 degrees, and thus the polarizer 114 will block the reflected linearly polarized light 2a′ from emitting to the ambient. Therefore, the reflected linearly polarized light 2a′ will not enter the eyes of the user, thereby enhancing the contrast of the display device 100/100′. Especially, the image contrast performance of the display device 100/100′ under the strong light environment such as the sun light is enhanced.

However, in the display device 100/100′ as shown in FIGS. 2-5, because the first transparent substrate 106 (see FIGS. 2 and 3) within the touch module 104 still employs the rigid material such as glass, it is still disadvantageous in decreasing the weight of the display device 100/100′, and the display device 100/100′ is inflexible as the conventional display device.

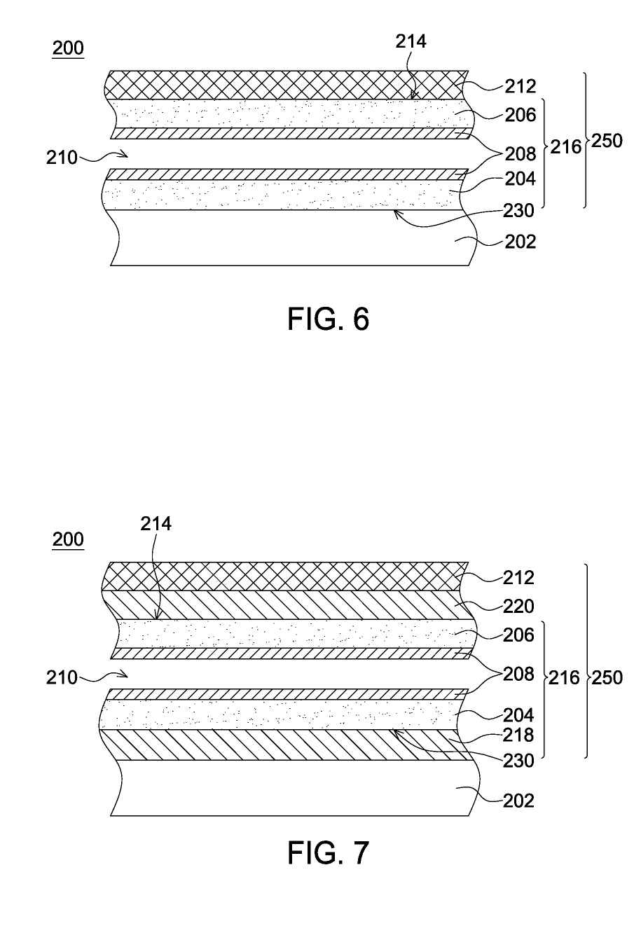

Referring to a series of schematic views such as FIGS. 6 and 7, the cross-section area of the display device according to another embodiment of the present invention are shown. In this embodiment, the touch module within the display device employs a substrate material lighter than the glass and thus has suitable flexibility.

Referring to FIG. 6, a cross-sectional view of a display device 200 according to an embodiment of the present invention is shown. The display device 200 includes a display module 202 and a touch module 250 disposed on the display module 202.

As shown in FIG. 6, for example, the display module 202 is, but not limited to, an image display device such as an LCD or an OLED. The display module 202 may also be a display device with another configuration. The touch module 250 includes a touch panel 216 and a polarizer 212 formed on a display surface 214 of the touch panel 204. Further, an embedding surface 230 of the touch panel 216 physically contacts with the surface of the display module 202. Here, no gap exists between the touch module 250 and the display module 202.

Here, the touch panel 216 main includes a first transparent substrate 204 and a second transparent substrate 206 opposite to each other. In this embodiment, both the first transparent substrate 204 and the second transparent substrate 206 employ substrates of the flexible material such as polyethylene terephthalate (PET). A transparent conductive layer 208 is formed respectively on surfaces of the first transparent substrate 204 and the second transparent substrate 206. A surface of the second transparent substrate 206 is defined as the display surface 214. A surface of the first transparent substrate 204 is defined as the embedding surface 230. A gap 210 exists between the first transparent substrate 204 and the second transparent substrate 206, so as to prevent the transparent conductive layers 208 formed on the first transparent substrate 204 and the second transparent substrate 206 from contacting with each other when the touch module 250 is touched and pressed. Here, for example, the touch panel 216 is, but not limited to, a resistive touch panel, and the touch panel 216 may also be a touch panel of another type, such as a capacitive touch panel.

In this embodiment, because both the first transparent substrate 204 and the second transparent substrate 206 employ the flexible material such as PET, the touch module 250 may have suitable flexibility, and thus is suitable for the display device with non-planar display panel. Furthermore, because the touch panel 216 does not use the conventional glass material, the overall weight of the touch module 250 is reduced, thereby enhancing the portability of the display device 200. Further, the touch panel 216 substantially contacts with the display module 202 without any gap existing there-between, the internal reflection problems caused by the gap between the touch module and the display module can be further alleviated, thereby improving the image contrast

As shown in FIG. 7, in another embodiment, a first retarder film 218 and a second retarder 220 are further added to the display device 200 shown in FIG. 6, which are respectively attached to the embedding surface 230 of the first transparent substrate 204 and the display surface 214 of the second transparent substrate 206. The first retarder film 218 and the second retarder film 220 are, for example, ¼ wavelength (¼λ) retarder films, and λ is, for example, the wavelength of the visible light. In this embodiment, the display module 202 substantially contacts with the retarder film 218, and the polarizer 212 substantially contacts with the retarder film 220. In this embodiment, by disposing the first retarder film 218 and the second retarder film 220 respectively on the display surface 230 and the embedding surface 214 of the touch panel 216 within the display device 200, the reflection of the ambient light in the touch panel 216 and between the touch module 250 and the display module 202 after entering the display device 200 is alleviated, thereby enhancing the contrast of the image display surface and the display device under strong light, and alleviating the internal reflection problems encountered by the conventional display device.

FIGS. 8 and 9 are a series of schematic views, and explosive views (i.e., polarization principle) of the display device shown in FIG. 7 are shown.

As shown in FIG. 8, the polarizer 212 is, for example, a linear polarizer. A grating 213 having an extending direction I is disposed on the polarizer 212, for filtering the light. The second retarder film 220 is disposed behind the polarizer 212, and has a fast axis grating 221 with a 45 degrees deviation angle from the extending direction of the grating 213 of the polarizer 212. The second retarder film 220 is, for example, a ¼ wavelength retarder film, or another optical component with the same deflection function well known by those skilled in the art. The touch plane 216 is disposed behind the second retarder film 220. The first retarder film 218 is disposed behind the touch panel 216, and has a fast axis grating 219 with the same deviation angle as the extending direction of the fast axis grating 221 of the retarder film 220. In this embodiment, the retarder film 218 may also be, for example, a ¼ wavelength (¼λ) retarder film, or another optical component with the same deflection function well known by those skilled in the art.

In the display device as shown in FIG. 8, after an incident light 3 enters the polarizer 212 of the display device, an incident linearly polarized light 3a with an incident polarization direction similar to the extending direction I of the grating 213 on the polarizer 212 is thus formed. After the incident linearly polarized light 3a enters and passes through the retarder film 220, an incident circularly polarized light 3b is formed, which enters and passes through the touch panel 216, and then proceeds to the first retarder film 218. At this time, most of the incident circularly polarized light 3b forms an incident linearly polarized light 3c with a direction 90 degrees deviating from the extending direction I of the grating 213 on the polarizer 212. The incident linearly polarized light 3c further enters the display module 202.

As shown in FIG. 9, when the incident linearly polarized light 3c enters the display module 202, a portion of the incident linearly polarized light 3c is reflected from the surface of the display module, the reflected light (not shown) proceeds towards the retarder film 218, and forms a reflected circularly polarized light 3b′ after passing through the retarder film 218. After the reflected circularly polarized light 3b′ enters and passes through the touch panel 216 and the second retarder film 220, a reflected linearly polarized light 3a′ is thus formed, which proceeds to the polarizer 212. Due to the 90 degrees deviation angle between the polarization direction of the reflected linearly polarized light 3a′ and the extending direction I of the grating 213, the polarizer 212 can block the reflected linearly polarized light 3a′ from passing through the polarizer 212 to enter the ambient.

It can be acquired from the implementation of FIGS. 7, 8, 9 that, by disposing the second retarder film 220 and the first retarder film 218 within the display device 200, the reflected circularly polarized light 3b′ generated in the touch module within the display device 200 by the ambient incident light can be converted into the reflected linearly polarized light 3a′ with as phase having been offset by 90 degrees, and thus the polarizer 212 is able to block the reflected linearly polarized light 3a′ from emitting to the ambient. Therefore, the reflected linearly polarized light 3a′ will not enter the eyes of the user, thereby enhancing the contrast of the display device 200, especially facilitating the enhancement of the image contrast performance of the display device 200 under strong light such as the sun light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch module, comprising:
a touch panel, having a display surface and an embedding surface;
a first retarder film, disposed on the display surface;
a second retarder film, disposed on the embedding surface; and
a polarizer, disposed on the first retarder film.

2. The touch module as claimed in claim 1, wherein the polarizer is a linear polarizer having a first grating extending along a first direction.

3. The touch module as claimed in claim 2, wherein the first retarder film and the second retarder film are of a ¼ wavelength retarder film, and the first retarder film and the second retarder film respectively have a fast axis grating, wherein the first retarder film and the second retarder film are arranged such that a 90 degrees deviation angle exists between extending directions of the two fast axis of the first retarder film and the second retarder film.

4. The touch module as claimed in claim 1, wherein the touch panel comprises a rigid substrate.

5. The touch module as claimed in claim 4, wherein the rigid substrate is a glass substrate.

6. The touch module as claimed in claim 1, wherein the touch panel is substantially consisting of a flexible substrate.

7. The touch module as claimed in claim 6, wherein the flexible substrate is a polyethylene terephthalate (PET) substrate.

8. The touch module as claimed in claim 1, wherein the touch panel is a resistive touch panel or a capacitive touch panel.

9. A display device, comprising:
a display module; and
a touch module as claimed in claim 1, disposed on the display module.

10. The display device as claimed in claim 9, wherein the display module is a liquid crystal display (LCD) device or an organic light emitting display (OLED) device.

11. The display device as claimed in claim 9, wherein the second retarder film of the touch module substantially contacts with the display module.

12. The display device as claimed in claim 9, wherein a gap exists between the touch module and the display module.

13. A touch module, comprising:
a touch panel, having a display surface and an embedding surface opposite to each other; and
a polarizer, disposed on the display surface of the touch panel and substantially contacting with the touch panel.

14. The touch module as claimed in claim 13, wherein the polarizer is a linear polarizer having a first grating extending along a first direction.

15. The touch module as claimed in claim 14, wherein the touch panel is substantially consisting of a flexible substrate only.

16. The touch module as claimed in claim 15, wherein the flexible substrate is a polyethylene terephthalate (PET) substrate.

17. The touch module as claimed in claim 13, wherein the touch panel is a resistive touch panel or a capacitive touch panel.

18. A display device, comprising:
a display module; and
a touch module as claimed in claim 13, disposed on the display module, and the embedding surface of the touch module substantially contacting with the display module.

19. The display device as claimed in claim 18, wherein the display module is a liquid crystal display device or organic light emitting display (OLED) device.
